(19) United States
(12) Patent Application Publication
(10) Pub. No.: US 2022/0398100 A1
(43) Pub. Date: Dec. 15, 2022

(54) PROCESSORS EMPLOYING MEMORY DATA BYPASSING IN MEMORY DATA DEPENDENT INSTRUCTIONS AS A STORE DATA FORWARDING MECHANISM, AND RELATED METHODS

(71) Applicant: Microsoft Technology Licensing, LLC, Redmond, WA (US)

(72) Inventors: Yusuf Cagatay Tekmen, Raleigh, NC (US); Rodney Wayne Smith, Raleigh, NC (US); Shivam Priyadarshi, Apex, NC (US); Milind A. Choudhary, Durham, NC (US); Kiran Ravi Seth, Raleigh, NC (US)

(21) Appl. No.: 17/343,442

(22) Filed: Jun. 9, 2021

(51) Int. Cl. G06F 9/38; G06F 9/30

(52) U.S. Cl. CPC G06F 9/3826; G06F 9/3802; G06F 9/3836; G06F 9/30043; G06F 9/30101

(57) ABSTRACT

Processors employing memory bypassing in memory data dependent instructions as a store data forwarding mechanism, and related methods. To reduce stalls of memory data dependent, load-based instructions, a memory data dependency detection circuit is configured to detect a memory hazard between a store-based instruction and a load-based instruction based on their opcodes and designation/source operands. Some store-based and load-based instructions have opcodes identifying these instructions as having respective store and load address operand types that can be compared without resolution of their respective store and load addresses. For these detected types of instructions, the memory data dependency detection circuit is configured to determine if a source operand of a load-based instruction matches a target operand of a store-based instruction to detect a memory hazard earlier in the instruction pipeline. Identifying memory hazards earlier in an instruction pipeline can allow memory dependent instructions to be processed with avoided or reduced stalls.

### FIELD OF THE DISCLOSURE

The technology of the disclosure relates to processor-based systems employing a central processing unit (CPU), also known as a “processor,” and more particularly to identifying memory dependent, consumer load instructions for fast forwarding of source data to the load instruction for processing.

### BACKGROUND

Microprocessors, also known as “processors,” perform computational tasks for a wide variety of applications. A conventional microprocessor includes a central processing unit (CPU) that includes one or more processor cores, also known as “CPU cores.” The CPU executes computer program instructions (“instructions”), also known as “software instructions” to perform operations based on data and generate a result, which is a produced value. An instruction that generates a produced value is a “producer” instruction. The produced value may then be stored in memory, provided as an output to an input/output (“I/O”) device, or made available (i.e., communicated) as an input value to another “consumer” instruction executed by the CPU, as examples. Examples of producer instructions are load instructions and read instructions. A consumer instruction is dependent on the produced value produced by a producer instruction as an input value to the consumer instruction for execution. These consumer instructions are also referred to as dependent instructions on a producer instruction. Said another way, a producer instruction is an influencer instruction that influences the outcome of the operation of its dependent instructions as influenced instructions. For example, FIG. 1 illustrates a computer instruction program 100 that includes producer and consumer instructions dependent on the producer instructions. For example, instruction I0 is a producer instruction in that it causes a processor to store a produced result in register ‘R1’ when executed. Instruction I3 is a dependent instruction on instruction I0, because register ‘R1’ is a source register of instruction I3. Instruction I3 is also a producer instruction for register ‘R6’.

One example of a producer instruction is a store instruction. A store instruction includes a source of data to be stored and a target (e.g., a memory location or register) that identifies where the sourced data is to be stored. A subsequent load instruction that directly or indirectly names a source that is the same target/destination of the store instruction is a consumer instruction of the store instruction. If this target and source of the respective store and load instructions are the same memory address, the load instruction has what is known as a “memory data dependency” or “memory dependence” on the store instruction. An instruction pipeline in a processor is designed to schedule issuance of instructions to be issued once its source data is ready and available. However, in the case of a consumer load instruction having a load memory address (“load address”) as its source, substantial delay could be incurred in not issuing the consumer load instruction until its producer store instruction is executed and its source data stored at its target store memory address (“store address”). Thus, in many modern processor designs, an instruction pipeline in the processor is employed with a mechanism to accelerate the return of loaded data to be ready and available for a load instruction as a consumer instruction, when the source address of a store instruction is the same address as the load address of a subsequent load instruction. The store address and load address of a respective store and subsequent load instruction being the same address is referred to as a “memory hazard.” This mechanism can be referred to as a store-forward mechanism or circuit, where the source data at a named store address of a producer store instruction is forwarded in a forward path in the instruction pipeline to a consumer load instruction having the same load address. The store-forwarded data may be the actual store data encoded in store instruction itself or may be sourced from a local or intermediate physical storage in which the store data is stored until ready to be forwarded to a pipeline stage to be consumed by its producer load instruction. In this manner, issuance of the consumer load instruction does not have to be delayed until its producer store instruction is fully executed and its source data written to its target memory address.

However, a store-forward mechanism has to have knowledge of the memory hazard between a producer store instruction and a consumer load instruction to know to forward store data to a load instruction in the instruction pipeline. The store-forward mechanism can employ a mechanism to detect the memory hazard by comparing a known store address of a store instruction to a known load address of a subsequent load instruction in the instruction pipeline. The load instruction may have to be stalled in the instruction pipeline until the store data of the producer store instruction is available, because the memory hazard was not able to be detected in an early stage of the instruction pipeline. Alternatively, a store-forward mechanism can make a prediction that a memory hazard exists between a store instruction and a subsequent load instruction in the instruction pipeline. However, if the prediction of the memory hazard is incorrect, the load instruction and younger instructions that are memory data dependent may have to be flushed, re-fetched, and executed thus reducing pipeline throughput.

### SUMMARY

Exemplary aspects disclosed herein include processors employing memory bypassing in memory data dependent instructions as a store data forwarding mechanism. Related methods are also disclosed. The processor includes an instruction processing circuit that includes an instruction pipeline(s) with a number of instruction processing stages configured to pipeline the processing and execution of fetched instructions in an instruction stream. The instruction processing circuit can stall a memory data dependent, load-based consumer instruction that creates a memory hazard with a stored-based producer instruction until the produced value from execution of the store-based instruction is written to its target (i.e., destination) memory address. In exemplary aspects, to reduce stalls of memory data dependent, load-based instructions, the instruction processing circuit includes a memory data dependency detection circuit. The memory data dependency detection circuit is configured to detect a memory data hazard between a store-based instruction and a load-based instruction based on the opcodes of the store-based instruction and a load-based instruction. Some store-based and load-based instructions have opcodes that identify these instructions as having respective store and load address operand types that can be compared without having to resolve their actual respective store and load addresses. For example, the store or load address may include a base register with a zero (0) offset or base register with an immediate offset. For these detected types of instructions, the memory data dependency detection circuit is configured to determine if a source operand of a load-based instruction matches a target operand of a store-based instruction as its producer instruction. The memory data dependency detection circuit can detect memory hazards earlier in the instruction pipeline, such as in an in-order stage and/or prior to issuance, between these types of stored-based and load-based instructions based on their opcodes and their named store and load addresses matching. The memory data dependency detection circuit can then break the memory data dependency between the load-based instruction and the store-based instruction by bypassing the memory data dependent target of the load-based instruction to replace it with a direct mapping to the assigned designation (e.g., a physical register identity) of the store-based instruction where its produced value is stored. For example, this replacement may be performed by updating the mapping of the logical register of the target of the load-based instruction to the physical register of the assigned designation of the store-based instruction. This is opposed to potentially having to stall the load-based instruction until its memory-dependent store-based instruction is executed to resolve the source load address of the load-based instruction. Removing the memory data dependency of the load-based instruction on a store-based instruction removes the store-based instruction from the critical execution path of the load-based instruction. Identifying memory hazards earlier in an instruction pipeline can allow memory dependent instructions to be processed with avoided or reduced stalls in the instruction pipeline.

In exemplary aspects, the memory data dependency detection circuit is configured to detect if a store-based instruction has an opcode that identifies the store-based instruction as having a target operand that can be compared without the actual store address represented by the target operand being known (i.e., resolved). The actual store address represented by the target operand of the store-based instruction may not be resolved until a later stage of processing in the instruction processing circuit and/or until its execution. For example, a target store address of a stack pointer with an offset can be compared to a source operand of a load-based instruction naming the same stack pointer and offset without the memory address of the stack pointer having to be known. In response to detection of a store-based instruction having a target store address type that can be compared without resolving its store address, the memory data dependency detection circuit is configured to store the target assigned to the target operand (e.g., the identity of an assigned physical register in a register mapping table) of the store-based instruction. When the memory data dependency detection circuit encounters a subsequent load-based instruction that has opcode identifying the load-based instruction as having a source operand that can be compared without the actual load address represented by the source operand being known, the memory data dependency detection circuit can determine if its source load address matches the target source address of a previously encountered store-based instruction. If there is a match, this means a memory hazard exists between the store-based instruction and the memory dependent, load-based instruction. In response to detecting this memory hazard, the memory data dependency detection circuit can replace (i.e., bypass) the mapping of the target (e.g., the identity of its logical register) assigned to the target operand of the load-based instruction with the assigned target (e.g., its physical register) previously stored for the store-based instruction. For example, a register mapping table can be updated to map the logical register for the target of the load-based instruction to the same physical register mapped to the target of the store-based instruction. In this manner, the target operand of the load-based instruction is bypassed from its normal assigned target, to the assigned designation of its memory dependent, producer store-based instruction where its produced value to be consumed is actually stored. Thus, when the load-based instruction is processed in the instruction pipeline, the target of the load-based instruction is already assigned to a target containing the loaded data that is the produced value generated by previous execution of its producer store-based instruction. This is opposed to the load address in the source operand of the load-based instruction having to be resolved by execution of its memory data dependent store-based instruction before the load-based instruction can be issued for execution to load the data at the source load address into its assigned target.

In another exemplary aspect, the processor includes one or more memory data dependency reference circuits that are each configured to store assigned targets (e.g., an identity of the physical register) assigned to the target operand type of a store-based instruction that can be compared without the actual store address represented by the target operand being known. A memory data dependency reference circuit may be provided for different types of memory address types that can be named as source and/or target operations of store-based and load-based instructions that can be compared without such memory addresses having to be resolved. For example, a memory data dependency reference circuit may be provided for storing assigned targets for a store-based instruction whose opcode is based on its target operand type being based on the stack pointer. The memory data dependency reference circuit can be an array (e.g., a circular array) that includes entries that can be accessed at an offset from a starting point identified by a starting pointer corresponding to a base memory address type. This is so that if a store-based instruction names a target operand with an offset, that same offset can be used to access an entry in the corresponding memory data dependency reference circuit at the same offset from the start pointer for look up of the stored assigned target of the store-based instruction without having to know the actual store address.

Note that the memory data dependency detection circuit can also be configured to identify other younger instructions that have a memory data dependency on the load-based instruction that has memory data dependency on a store-based instruction based on the source operands of the younger instructions. For example, a younger consumer instruction may name a source operand that is the same as a target operand of the load-based instruction, which is memory data dependent on the target operand of a store-based instruction. In this regard, the subsequent consumer instruction also has memory data dependency on the same store-based instruction from which the load-based instruction has a memory data dependency. The memory data dependency detection circuit can be configured to identify the additional memory hazard created by the subsequent consumer instruction and bypass the mapping of the source assigned to the source operand of such subsequent consumer instruction to the assigned target previously stored for the store-based instruction. In this manner, the source operand of the subsequent consumer instruction is bypassed from its normal named source, to the assigned target of its memory data dependent, producer store-based instruction where its produced value to be consumed is actually stored. Thus, when the subsequent consumer instruction is processed in the instruction pipeline, the instruction processing circuit can process the subsequent consumer instruction based on obtaining its source data for a named source operand directly through the bypassed target storing the produced value for such source operand that was generated by execution of its producer, store-based instruction.

In this regard, in one exemplary aspect, a processor is disclosed. The processor comprises an instruction processing circuit comprising one or more instruction pipelines. The instruction processing circuit is configured to fetch a plurality of instructions from a memory into an instruction pipeline among the one or more instruction pipelines. The instruction processing circuit also comprises a memory data dependency detection circuit. The memory data dependency detection circuit is configured to receive a load-based instruction among the plurality of instructions assigned to the instruction pipeline, the load-based instruction comprising a source operand and a target operand. The memory data dependency detection circuit is also configured to determine based on an opcode of the load-based instruction if the source operand of the load-based instruction can be compared without a load address of the source operand being resolved. In response to determining the source operand of the load-based instruction can be compared without the load address being resolved, the memory data dependency detection circuit is configured to index a source entry among a plurality of source entries in a memory data dependency reference circuit based on the source operand of the load-based instruction, retrieve a source tag stored in the indexed source entry in the memory data dependency reference circuit, and map the retrieved source tag to an assigned target of the target operand of the load-based instruction.

In another exemplary aspect, a method of removing a memory data dependency between a store-based instruction and a load-based instruction in a processor is disclosed. The method comprises fetching a plurality of instructions from a memory into an instruction pipeline among one or more instruction pipelines. The method also comprises receiving a load-based instruction among the plurality of instructions assigned to the instruction pipeline, the load-based instruction comprising a source operand and a target operand. The method also comprises determining based on an opcode of the load-based instruction if the source operand of the load-based instruction can be compared without a load address of the source operand being resolved. In response to determining the source operand of the load-based instruction can be compared without the load address being resolved, the method comprises indexing a source entry among a plurality of source entries in a memory data dependency reference circuit based on the source operand of the load-based instruction, retrieving a source tag stored in the indexed source entry in the memory data dependency reference circuit, and mapping the retrieved source tag to an assigned target of the target operand of the load-based instruction.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is an exemplary instruction stream that can be executed by an instruction processing circuit in a processor and to illustrate source dependencies between consumer instructions and producer instructions that provide values to such registers;

FIG. 2 is a diagram of an exemplary instruction processing circuit in a processor that includes one or more instruction pipelines for processing computer instructions for execution, and wherein the processor further includes an exemplary memory data dependency detection circuit configured to bypass a target mapped to a target operand of a load-based instruction with the designation assigned to a store-based instruction, based on a detected memory data dependency between the store-based instruction and a consumer load-based instruction based on their opcodes as having matching target and source operand types that can be compared without their actual target and source addresses being known;

FIG. 3 is an instruction stream of exemplary instructions to illustrate a memory data dependency between a store-based and a load-based instruction based on their opcodes as having matching target and source operand types that can be compared without their target and source addresses being known;

FIG. 4 is a flowchart illustrating an exemplary process of a memory data dependency detection circuit, such as the memory data dependency detection circuit in FIG. 2, detecting a store-based instruction having an opcode calling for a target operand representing a store address that can be compared without the actual store address being known, and storing an assigned target for such target store address in a memory data dependency reference circuit for later comparison to a source load address operand of a load-based instruction matching the target store address operand of the store-based instruction;

FIG. 5 is diagram illustrating an exemplary memory data dependency reference circuit that has one or more source entries configured to store source tags indicating assigned targets of target operands of store-based instructions having an opcode identifying the target operand of the store-based instruction as being comparable without its store address being known;

FIG. 6 is diagram illustrating a plurality of multiple memory data dependency reference circuits assigned to respective different address operand types;

FIG. 7 is a flowchart illustrating an exemplary process of a memory data dependency detection circuit, such as the memory data dependency detection circuit in FIG. 2, performing a look up in a memory data dependency reference circuit corresponding to a source load address operand of a load-based instruction matching the target store address operand of the store-based instruction, to bypass the target of the load-based address of the load-based instruction with the stored target for the store-based instruction;

FIG. 8 is a flowchart illustrating an exemplary process of a load check detection circuit in the instruction processing circuit in FIG. 2 initiating a corrective action if the data loaded by execution of a load-based instruction having an opcode calling for a source operand representing a load address that can be compared without the load address being known does not match the load data in the bypassed target of the load-based address of the load-based instruction; and

FIG. 9 is a block diagram of an exemplary processor-based system that includes a processor that includes an instruction processing circuit for executing instructions from program code, and wherein the processor can include a memory data dependency detection circuit, including, but not limited to, the memory data dependency detection circuit in FIG. 2, configured to bypass a target mapped to a target operand of a load-based instruction with the designation assigned to a store-based instruction, based on a detected memory data dependency between the store-based instruction and a consumer load-based instruction based on their opcodes as having matching target and source operand types that can be compared without their actual target and source addresses being known.

### DETAILED DESCRIPTION

Exemplary aspects disclosed herein include processors employing memory bypassing in memory data dependent instructions as a store data forwarding mechanism. Related methods are also disclosed. The processor includes an instruction processing circuit that includes an instruction pipeline(s) with a number of instruction processing stages configured to pipeline the processing and execution of fetched instructions in an instruction stream. The instruction processing circuit can stall a memory data dependent, load-based consumer instruction that creates a memory hazard with a stored-based producer instruction until the produced value from execution of the store-based instruction is written to its target (i.e., destination) memory address. In exemplary aspects, to reduce stalls of memory data dependent, load-based instructions, the instruction processing circuit includes a memory data dependency detection circuit. The memory data dependency detection circuit is configured to detect a memory data hazard between a store-based instruction and a load-based instruction based on the opcodes of the store-based instruction and a load-based instruction. Some store-based and load-based instructions have opcodes that identify these instructions as having respective store and load address operand types that can be compared without having to resolve their actual respective store and load addresses. For example, the store or load address may include a base register with a zero (0) offset or base register with an immediate offset. For these detected types of instructions, the memory data dependency detection circuit is configured to determine if a source operand of a load-based instruction matches a target operand of a store-based instruction as its producer instruction. The memory data dependency detection circuit can detect memory hazards earlier in the instruction pipeline, such as in an in-order stage and/or prior to issuance, between these types of stored-based and load-based instructions based on their opcodes and their named store and load addresses matching. The memory data dependency detection circuit can then break the memory data dependency between the load-based instruction and the store-based instruction by bypassing the memory data dependent target of the load-based instruction to replace it with a direct mapping to the assigned designation (e.g., a physical register identity) of the store-based instruction where its produced value is stored. For example, this replacement may be performed by updating the mapping of the logical register of the target of the load-based instruction to the physical register of the assigned designation of the store-based instruction. This is opposed to potentially having to stall the load-based instruction until its memory-dependent store-based instruction is executed to resolve the source load address of the load-based instruction. Removing the memory data dependency of the load-based instruction on a store-based instruction removes the store-based instruction from the critical execution path of the load-based instruction. Identifying memory hazards earlier in an instruction pipeline can allow memory dependent instructions to be processed with avoided or reduced stalls in the instruction pipeline.

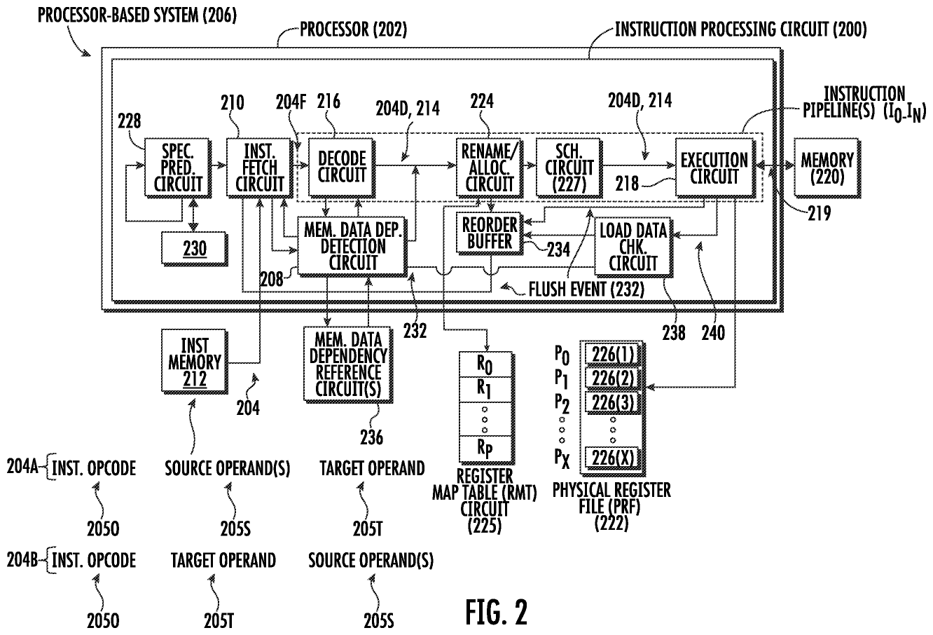

In this regard, FIG. 2 is a diagram of an exemplary instruction processing circuit 200 in a processor 202. The instruction processing circuit 200 includes one or more instruction pipelines I₀-I_{N} for processing computer instructions 204 for execution. The processor 202 can be part of a processor-based system 206 that includes other supporting circuitry and devices, such as external memory, input/output devices, etc. As discussed in more detail below, the instruction processing circuit 200 in this example includes an exemplary memory data dependency detection circuit 208 that is configured to detect a memory hazard between a store-based instruction 204 and a younger load-based instruction 204 based on the opcodes of the store-based instruction 204 and a load-based instruction 204. The memory data dependency detection circuit 208 is configured to identify store-based and load-based instructions that have opcodes that identify these instructions as having respective store and load address operand types that can be compared without having to resolve their actual respective store and load addresses. For example, the store or load address of such respective store-based or load-based instructions 204 may include a base register with a zero (0) offset or base register with an immediate offset. For these detected types of instructions 204, the memory data dependency detection circuit 208 is configured to determine if a source operand of a load-based instruction 204 matches a target operand of a store-based instruction 204 as its producer instruction. If the source operand of a younger load-based instruction 204 matches a target operand of a store-based instruction 204, the load-based instruction 204 has a memory data dependency on the store-based instruction 204. The memory data dependency detection circuit 208 can then break the memory data dependency between such memory dependent load-based and store-based instructions 204 by bypassing the memory dependent target of the load-based instruction 204 to replace it with a direct mapping to the assigned designation (e.g., a physical register identity) of the store-based instruction 204 where its produced value is stored. This is opposed to potentially having to stall the load-based instruction 204 until the store-based instruction is executed and the load address of the load-based instruction 204 is resolved and known. Removing the memory data dependency of the load-based instruction 204 on a store-based instruction 204 removes the store-based instruction 204 from the critical execution path of the load-based instruction 204.

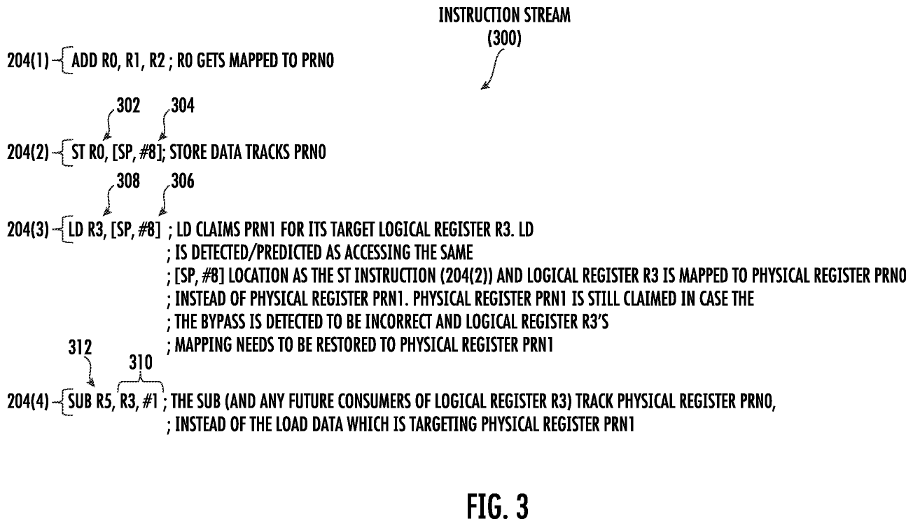

Before discussing further exemplary aspects of the instruction processing circuit 200 and the memory data dependency detection circuit 208 in FIG. 2, an example instruction stream 300 is first discussed to illustrate data dependence. The instruction stream 300 in FIG. 3 illustrates an example of a load-based instruction having a data dependence on a store-based instruction that can be bypassed and broken by the memory data dependency detection circuit 208 in FIG. 2. The instruction stream 300 can be processed and executed in the instruction processing circuit 200 in FIG. 2.

In this regard, as shown in FIG. 3, the instruction stream 300 includes a first instruction 204(1) in the instruction stream 300 that is an add instruction (ADD). When executed, the add instruction 204(1) causes the contents of logical registers R1 and R2 to be added together and the result stored in logical register R0. The instruction processing circuit 200 maps logical register R0 to a physical register, such as physical register PRN0 for example, for storing the produced result from execution of the add instruction 204(1). The next instruction 204(2) is a store instruction (ST) that names logical register R0 (mapped to physical register PRN0) as its source operand 302, and the memory location pointed to by the stack pointer (SP) with an immediate offset of eight (8) (#8) as its destination or target operand 304. Thus, when the store instruction 204(2) is executed, the contents of logical register R0 (i.e., the contents of physical register PRN0) is stored at the memory location pointed to by the value of the stack pointer (SP) with an offset of eight (8). The next instruction 204(3) is a load instruction (LD) that also has a pointer to the stack pointer (SP) with immediate offset of eight (8) as its source operand 306 and logical register R3 as the target operand 308. Thus, when the load instruction 204(3) is executed, the contents at the memory address pointed to by the stack pointer (SP) with offset of eight (8) is stored in the physical register (e.g., physical register PRN1) assigned to logical register R3. A subtract instruction SUB 204(4) subtracts the contents of logical register R3 by one (1) (#1) as its source operand 310 and stores the result in logical register R5 named as its target operand 312. Thus, as shown in the instruction stream 300 in FIG. 3, the load instruction 204(3) has a data dependence on the add instruction 204(1) and a data dependence (memory data dependence) on the store instruction 204(2). The load instruction 204(3) has a data dependence on the store instruction 204(2), because the load instruction 204(3) names a source operand 306 for a source load address that matches the target operand 304 for a target store address of the store instruction 204(2) (i.e., [SP, #8]). Thus, whatever data value is stored at the memory location pointed to by the stack pointer (SP) with an offset of eight (8) when the store instruction 204(2) is executed could also be the value loaded into register R3 as the target operand 308 named by the load instruction 204(3). This creates a memory hazard between the store instruction 204(2) and the load instruction 204(3). The load instruction 204(3) has a data dependence on the add instruction 204(1), because of its data dependence on the store-based instruction 204(2). This is because the data stored in logical register R0 by execution of the add instruction 204(1) will be loaded into a memory address pointed to by the stack pointer (SP) plus an offset of eight (8) by the store instruction 204(2). Thus, that same data at the memory address pointed to by the stack pointer (SP) plus an offset of eight (8) could be loaded into logical register R3 by execution of the load instruction 204(3). Further, the subtract instruction 204(4) also has a data dependence on the add instruction 204(1), because the data stored in logical register R3, that could be the same data stored in logical register R0 when the add instruction 204(1) is executed, is named as the source operand 310 of the subtract instruction 204(4).

In many processor designs, using the example instruction stream 300 in FIG. 3, the load instruction 204(3) and the subtract instruction 204(4) cannot be issued for execution until the store instruction 204(2) is executed based on the dependencies between these instructions 204(3), 204(4) and the store instruction 204(2). And the store instruction 204(2) cannot be issued for execution until the add instruction 204(1) is executed based on the data dependence of the store instruction 204(2) on the add instruction 204(1). This can cause pipeline stalls. In other processor designs, to reduce pipeline stalls when processing memory dependent load-based instructions, like load instruction 204(3) in FIG. 3, the instruction pipelines in the processor can be employed with a data store-forward mechanism. The store-forward mechanism accelerates the return of loaded data to be ready and available for a load-based instruction as a consumer instruction, when the source address of a store-based instruction is the same address as the load address of a subsequent, younger load instruction. In this manner, issuance of the consumer load-based instruction does not have to be stalled until its producer store-based instruction is fully executed and its source data written to its target memory address. However, a store-forward mechanism has to have knowledge of or make a prediction of the memory hazard between a producer store-based instruction and a consumer load-based instruction to know to forward store data to a load instruction in an instruction pipeline. The store-forward mechanism can employ a mechanism to detect the memory hazard by comparing a known store address of a store-based instruction to a known load-based address of a subsequent load instruction in the instruction pipeline. But this comparison may not be able to be performed until the store-based instruction has been executed and the load-based instruction processed in a later stage of the instruction pipeline. This can stall the load-based instruction as well as any other younger instructions that are dependent on the load-based instruction, thus reducing pipeline throughput.

However, as shown in the instruction stream 300 in FIG. 3, the store instruction 204(2) and the load instruction 204(3) have a data dependence that can be detected without the store address of the store instruction 204(2) being resolved. The store instruction 204(2) will have an opcode in this example that indicates the format of its target operand 304 as being a pointer to a base register (e.g., the stack pointer (SP) with an immediate offset. The load instruction 204(3) will also have an opcode in this example that indicates the format of its source operand 306 as being a pointer to a base register (e.g., the stack pointer (SP)) with an immediate offset. Thus, even though the true value of the source pointer (SP) used as a pointer for the store address of the store instruction 204(2) may not resolved until the store instruction 204(2) is processed in a latter stage of the instruction pipeline or executed, it can be known that the source operand 306 (i.e., the load address) of the load instruction 204(3) matches the target operand 304 (i.e., the store address) of the store instruction 204(2). Thus, as discussed below, and as an example, the memory data dependency detection circuit 208 in FIG. 2 can detect this condition when the source operand 306 of the younger load instruction 204(3) matches the target operand 304 of the store instruction 204(2). Thus, for the example instruction stream 300 in FIG. 3, the target assigned to the logical register R3 named in the target operand 308 of the load instruction 204(3) can be bypassed to be mapped to physical register PRN0 instead of PRN1. In this manner, the data dependence of the load instruction 204(3) on the store instruction 204(2) is broken. The load address named in the source operand 306 of the load instruction 204(3) no longer needs to be resolved for the load instruction 204(3) to be processed. The load instruction 204(3) can be processed and issued for execution irrespective of whether the store address named by the target operand 304 of the store instruction 204(2) has been resolved and stored in logical register R0. Further, the data dependence of the subtract instruction 204(4) on the load instruction 204(3) can also be broken. The source assigned to the logical register R3 named in the source operand 310 of the subtract instruction 204(4) can also be bypassed to be mapped to physical register PRN0 instead of PRN1.

Before discussing further exemplary aspects of the memory data dependency detection circuit 208 in FIG. 2 having the capability of breaking data dependence between a younger load-based instruction 204 and a store-based instruction 204 that have store and load address operand types that can be compared without having to resolve their actual respective store and load addresses, other aspects of the processor 202 and its instruction processing circuit 200 are first described below.

In this regard, the processor 202 in FIG. 2 may be an in-order or an out-of-order processor (OoP) as a non-limiting example. The processor 202 includes the instruction processing circuit 200 that includes an instruction fetch circuit 210 configured to fetch instructions 204 from an instruction memory 212 (“memory 212”). One example of a fetched instruction 204A includes an instruction opcode 205O (INST. OPCODE) indicating the instruction type, followed by one or more source operands 205S and a target operand 205T. Another example of a fetched instruction 204A include an instruction opcode 205O (“opcode 205O”) (INST. OPCODE) indicating the instruction type, followed by a target operand 205T followed by one or more source operands 205S. The instruction memory 212 may be provided in or as part of a system memory in the processor-based system 206, as an example. The instruction fetch circuit 210 in this example is configured to provide the instructions 204 as fetched instructions 204F into an instruction pipeline IP₀-IP_{N} as an instruction stream 214 in the instruction processing circuit 200 to be decoded in a decode circuit 216 and processed as decoded instructions 204D before being executed in an execution circuit 218. The produced value 219 generated by the execution circuit 218 from executing the decoded instruction 204D is committed (i.e., written back) to a storage location indicated by the destination of the decoded instruction 204D. This storage location could be memory 220 in the processor-based system 206 or a physical register P₀-P_{X} in a physical register file (PRF) 222, as examples.

With continuing reference to FIG. 2, once fetched instructions 204F are decoded into decoded instructions 204D, the decoded instructions 204D are provided to a rename/allocate circuit 224 in the instruction processing circuit 204. The rename/allocate circuit 224 is configured to determine if any register names in the decoded instructions 204D need to be renamed to break any register dependencies that would prevent parallel or out-of-order processing. The rename/allocate circuit 224 is also configured to call upon a register map table (RMT) circuit 225 to rename a logical source register operand and/or write a destination register operand of a decoded instruction 204D to available physical registers P₀-P_{X} in the PRF 222. The RMT circuit 225 contains a plurality of mapping entries each mapped to (i.e., associated with) a respective logical register R₀-R_{P}. The mapping entries are configured to store information in the form of an address pointer to point to a physical register P₀-P_{X} in the PRF 222. Each physical register P₀-P_{X} in the PRF 222 contains a data entry 226(0)-226(X) configured to store data for the source and/or destination register operand of a decoded instruction 204D. The instruction processing circuit 200 also includes a scheduler circuit 227 that is configured to control the scheduling or issuance of decoded instructions 204D to the execution circuit 218 to be executed once its sources of a decoded instruction 204D according to its named source operands are ready and available.

The instruction processing circuit 200 also includes a speculative prediction circuit 228 that is configured to speculatively predict a value associated with an operation. For example, the speculative prediction circuit 228 may be configured to predict a condition of a conditional control instruction 204, such as a conditional branch instruction, that will govern in which instruction flow path, next instructions 204 are fetched by the instruction fetch circuit 210 for processing. For example, if the conditional control instruction 204 is a conditional branch instruction, the speculative prediction circuit 228 can predict whether a condition of the conditional branch instruction 204 will be later resolved in the execution circuit 218 as either “taken” or “not taken.” In this example, the speculative prediction circuit 228 is configured to consult a prediction history indicator 230 to make a speculative prediction. As an example, the prediction history indicator 230 can contain a global history of previous predictions. The prediction history indicator 230 can be hashed with the program counter (PC) of a current conditional control instruction 204, for example, to be used for the prediction in this example. The execution circuit 218 is configured to generate a flush event 232 in response to detection of a misprediction of a conditional branch instruction 204.

If the outcome of a condition of a decoded speculatively predicted conditional control instruction 204D is determined to have been mispredicted in execution, the instruction processing circuit 200 can perform a misprediction recovery. In this regard, in this example, the execution circuit 218 stalls the relevant instruction pipeline IP₀-IP_{N} and flushes instructions 204F, 204D in the relevant instruction pipeline IP₀-IP_{N} in the instruction processing circuit 200 that are younger than the mispredicted conditional control instruction 204. A reorder buffer 234 is used to track the order of the instructions 204D in fetch order for refetching and/or replay of flushed instructions 204F, 204D.

With continuing reference to FIG. 2, as discussed above, the instruction processing circuit 200 includes the memory data dependency detection circuit 208 that is configured to employ memory bypassing in between memory data dependent load-based and store-based instructions as a form of a store data forwarding mechanism. The memory data dependency detection circuit 208 is configured to detect a memory hazard created by a memory data dependence of a load-based instruction 204 on a store-based instruction 204. The memory data dependency detection circuit 208 is configured to determine if an opcode of a received load-based instruction 204 that is fetched by the instruction fetch circuit 210 in FIG. 2 indicates that the source operand of the load-based instruction 204 can be compared to a target operand of a store-based instruction 204 without the load address represented by the source operand of the load-based instruction 204 actually being resolved. If so, the memory data dependency detection circuit 208 can be configured to determine if the source operand of the load-based instruction 204 matches the target operand of an older store-based instruction 204. If so, as discussed above using the example instruction stream 300 in FIG. 3, the memory data dependency detection circuit 208 can replace the target (e.g., the physical register) assigned to the target operand of the load-based instruction 204 with the target assigned to the target operand of older store-based instruction 204 to bypass the assigned target of the load-based instruction 204. This in effect breaks the memory data dependency between the load-based instruction 204 and the store-based instruction 204.

Before the memory data dependency detection circuit 208 can compare the source operand of the load-based instruction 204 to the target operand of an older store-based instruction 204, a mechanism is provided in the instruction processing circuit 200 in FIG. 2 for the memory data dependency detection circuit 208 to record the assigned targets of store-based instructions 204 having an opcode that indicates its target operand can be compared without the store address represented by its target operand being resolved. This check can be made as the store-based instructions 204 are fetched into and encountered in an instruction pipeline I₀-I_{N}, such as in an in-order stage of an instruction pipeline I₀-I_{N}. In this manner, the memory data dependency detection circuit 208 can use these recorded targets of store-based instructions 204 to determine memory data dependencies with younger load-based instructions 204 to bypass and break their memory data dependency if possible. In this manner, the load-based instruction 204 can be processed and dispatched without the store-based instruction having to be executed. The memory data dependency detection circuit 208 can use the recorded targets of such store-based instructions 204 to be compared to source operands of younger load-based dependents where its opcode indicates that its source operand can be compared without the load address of its source operand being resolved.

In this regard, the processor-based system 206 in FIG. 2 includes one or more memory data dependency reference circuits 236. The memory data dependency detection circuit 208 is configured to store an assigned target of a store-based instruction 204 that has an opcode that indicates its target operand can be compared without its store address being resolved, in the memory data dependency reference circuit 236. In this manner, when a younger load-based instruction 204 is encountered by the memory data dependency detection circuit 208 in an instruction pipeline I₀-I_{N}, if the opcode of the load-based instruction 204 indicates that its source operand can be compared without its load address being resolved, the memory data dependency detection circuit 208 can consult the memory data dependency reference circuits 236 to determine if an assigned target is present based on the source operand. If an assigned target is present in the memory data dependency reference circuit 236 for the source operand, this means that an assigned target was previously stored in the memory data dependency reference circuit 236 by the memory data dependency detection circuit 208 for a store-based instruction 204 that had a target operand with the same destination as in the source operand of the load-based instruction 204, meaning a memory data dependency is detected. The memory data dependency detection circuit 208 can then use this previously stored assigned target of the store-based instruction 204 to bypass the target operand of such load-based instruction 204.

As will also be discussed in more detail below, the instruction processing circuit 200 in FIG. 2 also includes a load check detection circuit 238. The load check detection circuit 238 can initiate a corrective action if the data loaded by execution of a load-based instruction 204F, 204D detected to have a memory data dependence on a store-based instruction 204F, 204D does not match the load data in the bypassed target for the load-based instruction 204F, 204D. This can happen, for example, if the base register that represents the load address of the load-based instruction 204F, 204D is updated after the store-based instruction 204F, 204D is executed from which the load-based instruction 204F, 204D is memory data dependent.

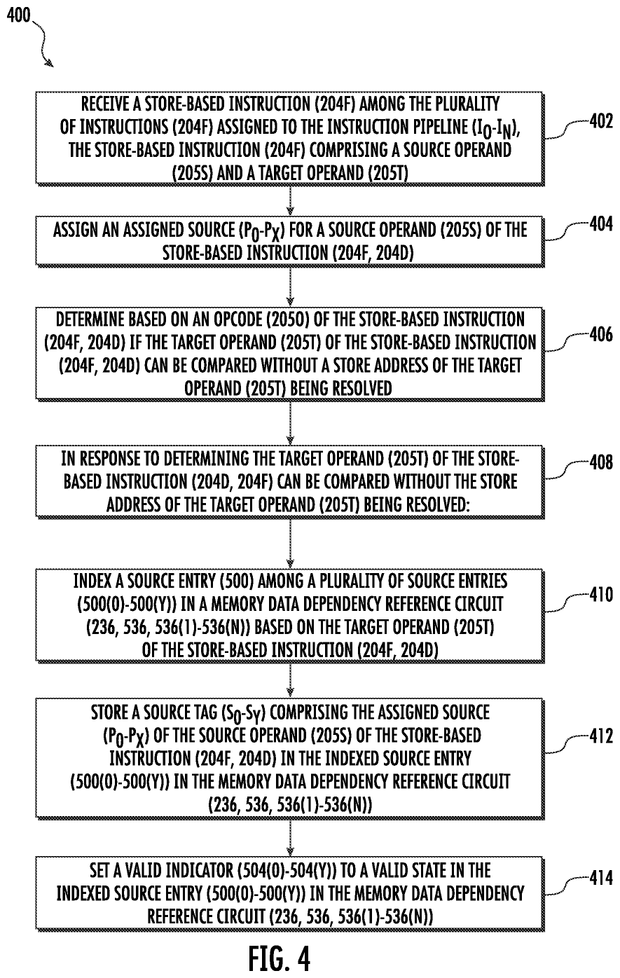

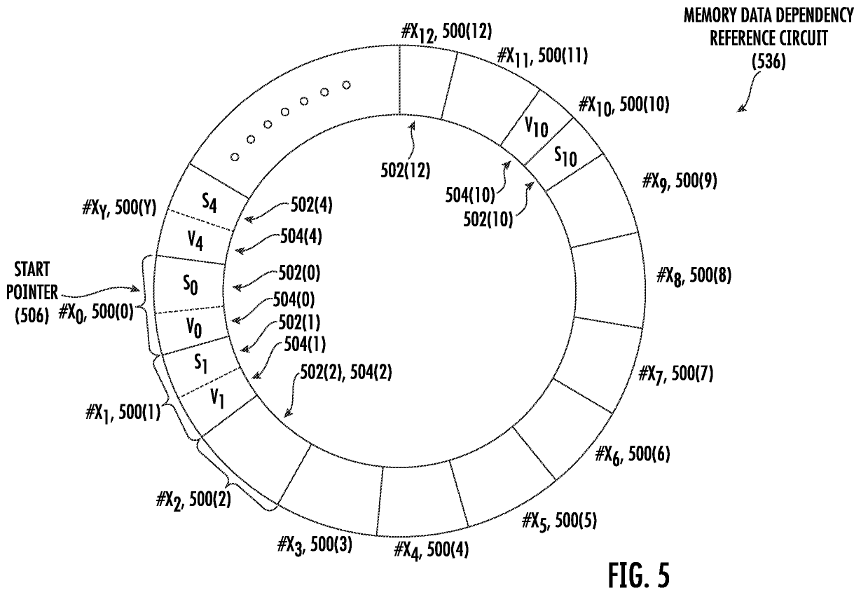

FIG. 4 is a flowchart illustrating an exemplary process 400 of a memory data dependency detection circuit, such as the memory data dependency detection circuit 208 in the instruction processing circuit 200 in FIG. 2, detecting a store-based instruction 204 having an opcode calling for a target store address operand identifying a store address that can be compared without the store address being resolved. The process 400 in FIG. 4 also involves storing an assigned target for an assigned target of a detected store-based instruction in the memory data dependency reference circuit 236 for later comparison to a source operand of a load-based instruction 204. FIG. 5 is diagram illustrating an exemplary memory data dependency reference circuit 536 that can be the memory data dependency reference circuit 236 in FIG. 2. As discussed in more detail below, the memory data dependency reference circuit 536 in FIG. 5 has one or more source entries configured to store source tags of assigned targets of store-based instructions 204 detected as having an opcode identifying its target operand as comparable without its store address being resolved. The process 400 in FIG. 4 will be discussed using the example of the memory data dependency detection circuit 208 and the memory data dependency reference circuit 536 in FIG. 5. Note however, that the process in FIG. 4 can be employed to other designs of a memory data dependency reference circuit other than the exemplary memory data dependency reference circuit 536 in FIG. 5.

In this regard, with reference to FIG. 4, the process 400 includes the instruction processing circuit 200 receiving a store-based instruction 204F assigned to the instruction pipeline I₀-I_{N} in the instruction processing circuit 200 in FIG. 2 as a result of the instruction fetch circuit 210 fetching instructions 204 (block 402 in FIG. 4). The store-based instruction 204F, when executed by the execution circuit 218, causes the instruction processing circuit 200 to store a data value in memory at a store address represented by a source operand 205S (e.g., a logical register) to a location represented by a target operand 205T. Such an example of a store-based instruction 204F is shown as the store instruction 204(2) in FIG. 3. The fetched store-based instruction 204F is decoded into a decoded store-based instruction 204D by the decode circuit 216 in the instruction processing circuit 200 in FIG. 2. As part of the processing of the decoded store-based instruction 204D, the rename/allocate circuit 224 is configured to rename a logical register in the source operand 205S of the store-based instruction 204D to an assigned, available physical register P₀-P_{X} as an assigned source in the PRF 222 (block 404 in FIG. 4). In this regard, the logical register in the source operand 205S in the RMT circuit 225 is assigned to point to an assigned physical register P₀-P_{X} in the PRF 222.

With continuing reference to FIG. 4, the memory data dependency detection circuit 208 in the instruction processing circuit 200 in FIG. 2 is configured to detect the store-based instruction 204D. The memory data dependency detection circuit 208 is coupled to the instruction pipeline I₀-I_{N} and able to detect instructions 204F, 204D inserted in an instruction pipeline I₀-I_{N}. The memory data dependency detection circuit 208 can be designed and configured to detect both fetched instructions 204F and/or decoded instructions 204D in an instruction pipeline I₀-I_{N}. The memory data dependency detection circuit 208 is configured to determine, based on the opcode 205O of the store-based instruction 204F, 204D, if the target operand 205T of the store-based instruction 204F, 204D is of a format type that can be compared to another operand without the store address represented by the target operand 205T being resolved (i.e., known) (block 406 in FIG. 4). For example, using the example store-based instruction 204(2) in FIG. 3, the target operand 304 is based on a base register of the stack pointer (SP) with an immediate offset of eight (8) (#8). Thus, in this example, the target operand 304 of the store-based instruction 204(2) is of a format type that can be compared without the actual address of the stack pointer (SP) being resolved. The actual store address represented by the target operand 205T of a store-based instruction 204F, 204D may not be resolved until a later stage of processing in the instruction processing circuit 200 and/or until its execution in the execution circuit 218. This can stall the processing of a load-based instruction 204F, 204D if its load address represented by its source operand 205S is dependent on the store address of a store-based instruction 204F, 204D.

With continuing reference to FIG. 4, if the memory data dependency detection circuit 208 determines that the target operand 205T of a store-based instruction 204F, 204D can be compared without the load address represented by its target operand 205T being resolved (block 408 in FIG. 4), the memory data dependency detection circuit 208 is configured to record the assigned target, which in this example is its assigned physical register P₀-P_{X} in the PRF 222, in the memory data dependency reference circuit 236 in FIG. 2. This is so that the assigned target can be assigned to (i.e., bypass) an assigned target of a younger, load-based instruction 204F, 204D that is detected to have a memory data dependency on the store-based instruction 204F, 204D to break this memory dependency.

As discussed above, FIG. 5 illustrates an example of a memory data dependency reference circuit 236 in FIG. 2 in the form of a memory data dependency reference circuit 536. In this example, the memory data dependency reference circuit 536 is a circular array of ‘Y+1’ number of source entries 500(0)-500(Y), where ‘Y’ can be any whole, positive number. The size of the memory data dependency reference circuit 536 can be a design decision that is based on patterns seen in execution of software. In an example of a memory data dependency reference circuit 536 corresponding to a base register as the stack pointer (SP), the number of source entries 500(0)-500(Y) can be chosen to be large enough to accommodate a push/pop of all the context to satisfy one level of call/return of a function. Each source entry 500(0)-500(Y) in this example includes a respective source tag field 502(0)-502(Y). Examples of the source tag fields 502(0), 502(1), 502(Y) are shown in FIG. 5. The source tag fields 502(0)-502(Y) are each configured to store a source tag S₀-S_{Y} identifying a target, which in this example can be a physical register P₀-P_{X} in the PRF 222. Each source entry 500(0)-500(Y) in this example also includes a respective valid indicator field 504(0)-504(Y) that is configured to store a valid indicator V₀-V_{Y} indicating if the source tag stored in the respective source tag field 502(0)-502(Y) is valid. For example, the valid indicator field 504(0)-504(Y) may be a 1-bit field where a ‘0’ value indicates an invalid state, and a ‘1’ value indicates a valid state.

With continuing reference to FIG. 5, a memory location for a start pointer 506 is also provided that points to a head source entry 500(0)-500(Y) in the memory data dependency reference circuit 536. For example, if the memory data dependency reference circuit 536 is assigned to store sources based on a base register of the stack pointer (SP), an address is stored in the start pointer 506 to point at the source entry 500(0)-500(Y) representing the stack pointer (SP) with no (i.e. zero) offset (#0), which in this example is source entry 500(0). Thus, the start pointer 506 “shadows” the relative position of the base register in memory. However, note that any of the source entries 500(0)-500(Y) could be the head of the source entries 500(0)-500(Y) for storing a target corresponding to an applicable base register at zero (0) offset. The subsequent source entries 500(1)-500(Y) in the memory data dependency reference circuit 536 correspond to offsets from a base register. For example, in this example, source entry 500(1) corresponds to one (1) offset (#1) from the base register assigned to source entry 500(0) pointed to by the start pointer 506. In this example, each source entry 500(1)-500(Y) represents a single byte offset from the base register. However, note that the memory data dependency reference circuit 536 could be configured for each adjacent source entry 500(1)-500(Y) to represent a multiple of a byte offset value, such as offsets of four (4) bytes. For examples, the offset increment of the source entries 500(1)-500(Y) may be based on the data bus width of the processor 202.

With reference back to FIG. 4, in this example, if the memory data dependency detection circuit 208 determines that the target operand 205T of a store-based instruction 204F, 204D can be compared without the load address represented by its target operand 205T being resolved (block 408 in FIG. 4), the memory data dependency detection circuit 208 is configured to index a source entry 500(0)-500(Y) in the memory data dependency reference circuit 536 (block 410 in FIG. 4). The indexed source entry 500(0)-500(Y) is based on the target operand 205T of the store-based instruction 204F, 204F (block 410 in FIG. 4). For example, using the example store instruction 204(2) in FIG. 3, if the memory data dependency reference circuit 536 is associated with the stack pointer (SP), the memory data dependency detection circuit 208 indexes source entry 500(8) to match the immediate offset of #8 based on its source operand [SP, #8]. In this manner, the target operand 205T of the store instruction 204(2) can be correlated to a specific indexed source entry 500(0)-500(Y) in the memory data dependency reference circuit 536 based on the base register and its offset, if any, without the actual store address represented by the target operand 205T being known or resolved. Thus, an offset from a base register in a target operand of a store-based instruction 204F, 204D can be correlated to an offset from the start pointer 506 pointing to the head source entry 500(0) in the memory data dependency reference circuit 536 to store the assigned source of its source operand 205S as the respective source tag S₀-S_{Y}.

With reference to FIG. 4, the memory data dependency detection circuit 208 is then configured to store a source tag S₀-S_{Y} of the assigned source of the source operand 205S of the store-based instruction 204F, 204D to the corresponding source tag field 502(0)-502(Y) of the indexed source entry 500(0)-500(Y) (block 412 in FIG. 4). In this example, the memory data dependency detection circuit 208 is also configured to set the valid indicator V₀-V_{Y} in the valid indicator field 504(0)-504(Y) of the indexed source entry 500(0)-500(Y) to a valid state. This is so that the memory data dependency detection circuit 208 can later determine that a source tag S₀-S_{Y} stored in a given source tag field 502(0)-502(Y) is valid (block 414 in FIG. 4). In this example of the store instruction 204(2) in FIG. 3 being detected by the memory data dependency detection circuit 208, the memory data dependency detection circuit 208 would store physical register P₀ assigned to its source operand 205S of logical register R3 as source tag T₈ in source tag field 502(8) of the indexed source entry 500(8) based on the base register with an immediate offset of eight (8) (#8) in the target operand 304. The memory data dependency detection circuit 208 would also set the valid indicator V₈ in the valid indicator field 504(8) of the indexed source entry 500(8) based on the target operand 304 of the store instruction 204(2).

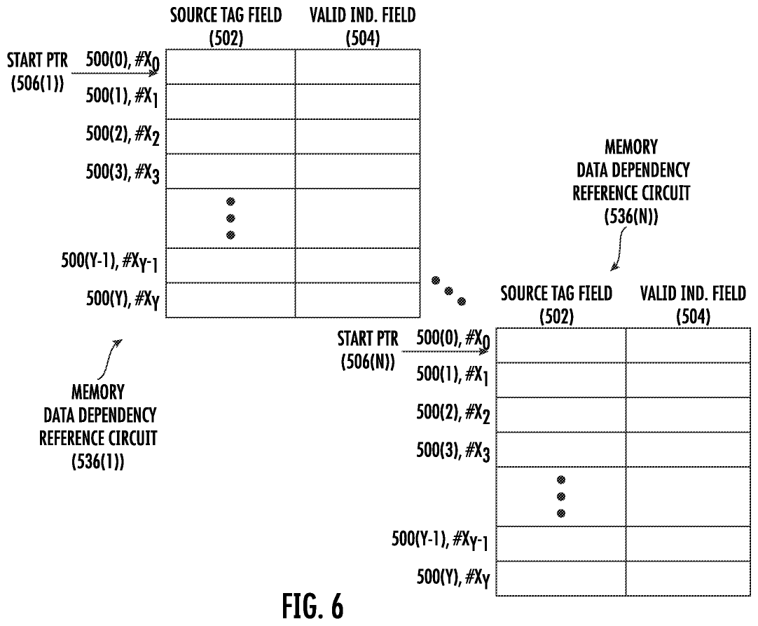

FIG. 6 is diagram illustrating a plurality of multiple memory data dependency reference circuits 536(1)-536(N) that can be provided in the processor-based system 206 in FIG. 2. In this manner, each base register that could be a target operand 205T of a store-based instruction 204F, 204D and a source operand 205S of a load-based instruction 204F, 204D has a designated memory data dependency reference circuit 536(1)-536(N) to store assigned sources as source tags. This allows detection of memory data dependencies between store-based and load-based instructions 204F, 204D for more types of base register target and source operands. The memory data dependency reference circuits 536(1)-536(N) can be organized like the memory data dependency reference circuit 536 in FIG. 5. Each memory data dependency reference circuit 536(1)-536(N) can be assigned to a different base register, for example. For example, memory data dependency reference circuit 536(1) could be assigned to the base register of the stack pointer (SP). Memory data dependency reference circuit 536(2) could be assigned the base register of logical register R0, and so on.

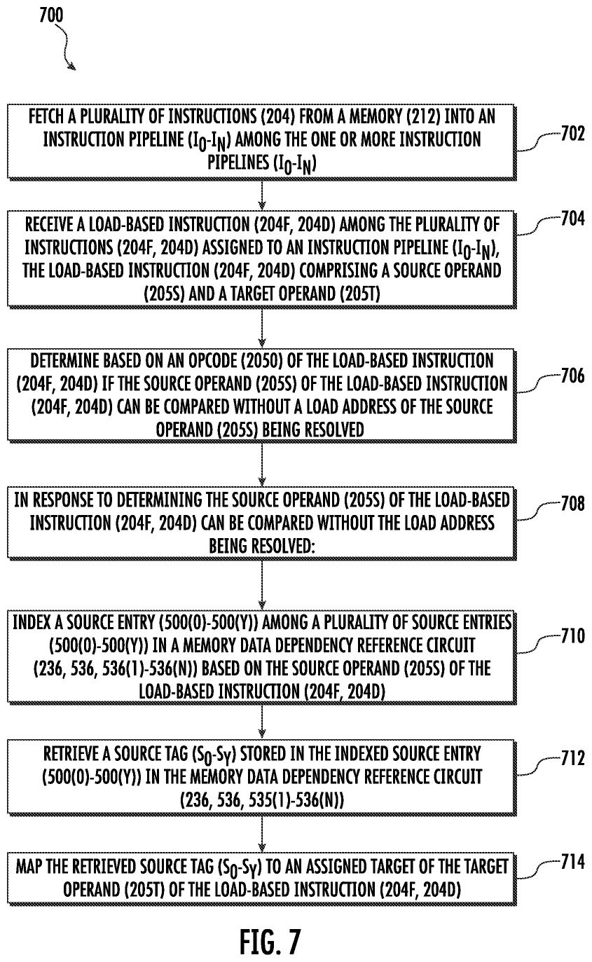

FIG. 7 is a flowchart illustrating an exemplary process 700 of a memory data dependency detection circuit, such as the memory data dependency detection circuit 208 in FIG. 2, detecting if a memory data dependency exists between a load-based instruction 204F, 204D and a previous, older store-based instruction 204F, 204D. As discussed above, it is desired that when load-based instructions 204F, 204D are received in an instruction pipeline I₀-I_{N} of the instruction processing circuit 200, that a memory data dependence that exists, if any, between such load-based instructions 204F, 204D and a previous store-based instruction 204F, 204D be detected. As discussed below, the memory data dependency detection circuit 208 is configured to perform a look-up in the memory data dependency reference circuit 236, which may be the memory data dependency reference circuit 536 in FIG. 5 or one of the memory data dependency reference circuits 536(1)-536(N) in FIG. 6 to determine if such a memory data dependency exists. If so, using the memory data dependency reference circuit 536 in FIG. 5 as an example, a valid source tag S₀-S_{Y} in a source tag field 502(0)-502(Y) of an indexed source entry 500(0)-500(Y) can be assigned as the bypassed assigned target of the load-based instruction 204F, 204D to remove the memory data dependency between the load-based instruction 204F, 204D and the store-based instruction 204F, 204D. The process 700 in FIG. 7 will be discussed using the example of the memory data dependency detection circuit 208 and the memory data dependency reference circuit 536 in FIG. 5. Note however, that the process 700 in FIG. 7 can be employed to other designs of a memory data dependency reference circuit other than the exemplary memory data dependency reference circuit 536 in FIG. 5.

In this regard, with reference to FIG. 7, the instruction processing circuit 200 in FIG. 2 is configured to fetch a plurality of instructions 204 from a memory 212 into an instruction pipeline I₀-I_{N} (block 702 in FIG. 7). The instruction processing circuit 200 is configured to receive a load-based instruction 204F, 204D assigned to an instruction pipeline I₀-I_{N} (block 704 in FIG. 4). The load-based instruction 204F, 204D includes a source operand 205S that represents a load address from which to load data from memory, and a target operand 205T to store the loaded data at the load address when executed. As part of the processing of the decoded load-based instruction 204D, the rename/allocate circuit 224 is configured to rename a logical register in the target operand 205T of the load-based instruction 204D to an assigned, available physical register P₀-P_{X} as an assigned source in the PRF 222. In this regard, the logical register in the target operand 205T in the RMT circuit 225 is assigned to point to an assigned physical register P₀-P_{X} in the PRF 222.

With continuing reference to FIG. 7, the memory data dependency detection circuit 208 is configured to determine based on an opcode 205O of the load-based instruction 204F, 204D if its source operand 205S of the load-based instruction 204F, 204D can be compared without the load address represented by the source operand 205S being resolved (block 706 in FIG. 7). For example, the load-based instruction 204F, 204D may have a source operand 205S that is based on a base register with an offset, such as the load instruction 204(3) in FIG. 3. If the memory data dependency detection circuit 208 determines that load-based instruction 204F, 204D can be compared without the load address represented by the source operand 205S being resolved (block 708 in FIG. 7), this means that the memory data dependency detection circuit 208 can check at this point, without the load address represented by the source operand 205S being resolved, if the load-based instruction 204F, 204D has a memory data dependency on a prior, older store-based instruction 204F, 204D. For example, in this case, the memory data dependency detection circuit 208 can detect if the load-based instruction 204F, 204D has a memory data dependency on a prior, older store-based instruction 204F, 204D before the store-based instruction 204F, 204D is issued for execution by the scheduler circuit 227 and/or executed by the execution circuit 218.

With continuing reference to FIG. 7, in response to the memory data dependency detection circuit 208 determining that load-based instruction 204F, 204D can be compared without the load address represented by the source operand 205S being resolved (block 708 in FIG. 7), the memory data dependency detection circuit 208 is configured to index a source entry 500(0)-500(Y) in the memory data dependency reference circuit 536 based on the source operand 205S of the load-based instruction 204F, 204D (block 710). For example, using the load-based instruction 204(3) in FIG. 3 as an example, the memory data dependency detection circuit 208 would index the memory data dependency reference circuit 536 corresponding to the base register of the stack pointer (SP) starting at its start pointer 506 offset by eight (8) to index the source entry 500(8). If the source tag field 502(8) for the source entry 500(8) has a valid source tag S₈ as indicated by the valid indicator V₈ in the valid indicator field 504(8), this means that an older store-based instruction 204F, 204D was detected by the memory data dependency detection circuit 208 that had an opcode 205O such that the store address represented by its target operand 205T could be compared without the store address being resolved. If the memory data dependency detection circuit 208 determines that the valid indicator V₀-V_{Y} in a valid indicator field 504(0)-504(Y) for an indexed source entry 500(0)-500(Y) indicates a valid state, the memory data dependency detection circuit 208 retrieves the source tag S₀-S_{Y} in the source tag field 502(0)-502(Y) of the indexed source entry 500(0)-500(Y) (block 712 in FIG. 7). The memory data dependency detection circuit 208 then maps the retrieved source tag S₀-S_{Y} in the source tag field 502(0)-502(Y) of the indexed source entry 500(0)-500(Y) to the assigned target of the target operand 205T of the load-based instruction 204F, 204D to bypass and override the memory data dependency of the load-based instruction 204F, 204D to the store-based instruction 204F, 204D (block 714 in FIG. 7).

As one example, the RMT circuit 225 can be used to store the retrieved source tag S₀-S_{Y} that is used by the memory data dependency detection circuit 208 to bypass the assigned target of the target operand 205T of the load-based instruction 204F, 204D. The memory data dependency detection circuit 208 can map the retrieved source tag S₀-S_{Y} to the logical register in the RMT circuit 225 assigned to the target operand 205T of the load-based instruction 204F, 204D as the new assigned target of the target operand 205T of the load-based instruction 204F, 204D. For example, using the load instruction 204(3) in FIG. 3 as an example, the memory data dependency detection circuit 208 could store physical register P₀ that was stored as a source tag S₀-S_{Y} in the memory data dependency reference circuit 536 for the assigned source operand 205S of a store-based instruction 204F, 204D, in the logical register R3 in the RMT circuit 225. The physical register P₁ originally assigned to the target operand 205T of the load-based instruction 204F, 204D would still remain assigned, because the load instruction 204(3) is still processed and executed by the execution circuit 218 in case the stack pointer (SP) is updated by another source between execution of the store instruction 204(2) and the load instruction 204(3), as discussed in more detail below.

With reference back to the process 700 in FIG. 7, if the memory data dependency detection circuit 208 determines that the valid indicator V₀-V_{Y} in a valid indicator field 504(0)-504(Y) for an indexed source entry 500(0)-500(Y) indicates an invalid state, the memory data dependency detection circuit 208 does not map the retrieved source tag S₀-S_{Y} in the source tag field 502(0)-502(Y) of the indexed source entry 500(0)-500(Y) to the assigned target of the target operand 205T of the load-based instruction 204F, 204D. This is because an invalid indexed source entry 500(0)-500(Y) cannot be used to determine a memory data dependency. In this situation, in one example, the memory data dependency detection circuit 208 can be configured to set the valid indicator V₀-V_{Y} to an invalid state in each source entry 500(0)-500(Y) in the memory data dependency reference circuit 536 as a way to flush the memory data dependency reference circuit 536. The memory data dependency detection circuit 208 can begin the process to refill assigned sources to subsequently detected store-based instructions 204F, 204D as provided in the process 400 in FIG. 4.

Further, the start pointer 506 can be updated to point to a new source entry 500(0)-500(Y) in the memory data dependency reference circuit 536 upon any write operations to the base register corresponding to the memory data dependency reference circuit 536 so that the start pointer 506 will always point to the base address of the base pointer to accurately point to the correct source entry 500(0)-500(Y). For example, the base register corresponding to the memory data dependency reference circuit 536 may be written between the detection of a store-based instruction 204F, 204D and a detected memory data dependent load-based instruction 204F, 204D.

Further, as noted in the example instruction stream 300 in FIG. 3, subsequent instructions 204F, 204D like the subtract instruction 204(4) can also have a memory data dependency on a store-based instruction 204F, 204D by virtue of such subsequent instructions 204F, 204D having a source operand 205S that matches the target operand 205T of a memory data dependent load-based instruction 204F, 204D. In this regard, in response to the memory data dependency detection circuit 208 determining that a source operand 205S of a load-based instruction 204F, 204D can be compared without its load address being resolved based on its opcode 205O, the memory data dependency detection circuit 208 can determine if a younger instruction 204F, 204D is memory data dependent on the store-based instruction 204F, 204D on which a load-based instruction 204F, 204D is memory data dependent. In this regard, the memory data dependency detection circuit 208 is configured to determine if the younger instruction 204F, 204D has a source operand 205S that matches the target operand 205T of the load-based instruction 204F, 204D. If so, the memory data dependency detection circuit 208 can also map the retrieved source tag S₀-S_{Y} in the source tag field 502(0)-502(Y) of the indexed source entry 500(0)-500(Y) for the load-based instruction 204F, 204D to the assigned source of the younger instruction 204F, 204D to break the memory dependence between the younger instruction 204F, 204D and the load-based and store-based instructions 204F, 204D.

As discussed above in the process 700 in FIG. 7, the indexed source entry 500(0)-500(Y) for a load-based instruction 204F, 204D may be determined by the memory data dependency detection circuit 208 to be invalid. In this case, the memory data dependency detection circuit 208 cannot bypass the assigned target for the target operand 205T of the load-based instruction 204F, 204D. In this example, the memory data dependency detection circuit 208 causes the physical register P₀-P_{X} claimed for the target operand 205T of the load-based instruction 204F, 204D to be written to the RMT circuit 225 for the logical register of the target operand 205T, if not already written This is so that the load-based instruction 204F, 204D can still write the loaded data to a separate location of the assigned physical register P₀-P_{X} in case the actual loaded data when the load-based instruction 204F, 204D is executed does not match the data stored in the source tag S₀-S_{Y} in the source tag field 502(0)-502(Y) of the indexed source entry 500(0)-500(Y) that is bypassed to the assigned target of the target operand 205T of the load-based instruction 204F, 204D. This could happen as a result of overwriting a source tag field 502(0)-502(Y) of an indexed source entry 500(0)-500(Y) of a memory data dependency reference circuit 536 since it is a circular queue in that example. This can also occur if the base register of the target operand 205T of the load-based instruction 204F, 204D is written between the execution of the store-based instruction 204F, 204D and execution of a memory data dependent load-based instruction 204F, 204D.

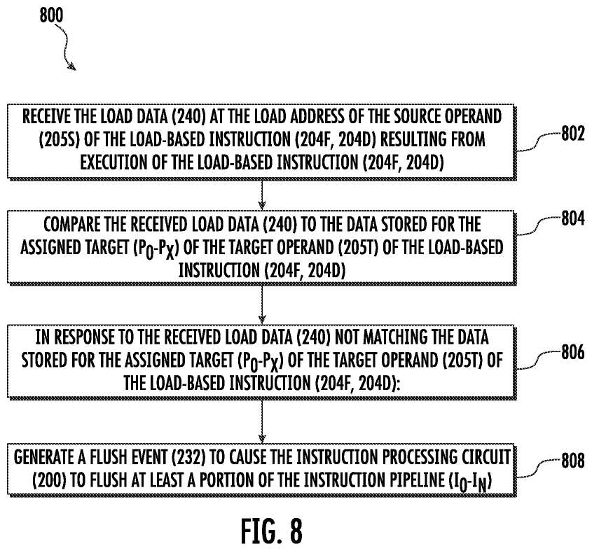

In this regard, FIG. 8 is a flowchart illustrating an exemplary process 800 of a load check detection circuit 238 in the instruction processing circuit 200 in FIG. 2. As discussed below, the load check detection circuit 238 can initiate a corrective action if the data loaded by execution of a load-based instruction 204F, 204D detected to have a memory data dependence on a store-based instruction 204F, 204D does not match the load data in the bypassed target for the load-based instruction 204F, 204D. The process 800 in FIG. 8 will be discussed using the example of the memory data dependency detection circuit 208 and the memory data dependency reference circuit 536 in FIG. 5. Note however, that the process 800 in FIG. 8 can be employed to other designs of a memory data dependency reference circuit other than the exemplary memory data dependency reference circuit 536 in FIG. 5.

In this regard, with reference to FIG. 8, the load check detection circuit 238 is configured to receive the load data 240 at the load address resolved from the source operand 205S resulting from execution of the load-based instruction 204F, 204D (block 802 in FIG. 8). If the load-based instruction 204F, 204D was previously detected as having a memory data dependency, for example, the load check detection circuit 238 can be configured to compare the received load data 240 to the data stored for the assigned target P₀-P_{X} of the target operand 205T of the load-based instruction 204F, 204D (block 804 in FIG. 8). The load check detection circuit 238 can perform and execute as part of an instruction pipeline I₀-I_{N} or part of a dedicated check pipe. If the received load data 240 does not match the data stored for the assigned target P₀-P_{X} of the target operand 205T of the load-based instruction 204F, 204D (block 806 in FIG. 8), the load check detection circuit 238 can generate a flush event 232 (block 808 in FIG. 8). This is done, because the bypassed target of the of the load-based instruction 204F, 204D performed previously by the memory data dependency detection circuit 208 was invalid. Thus, the load-based instruction 204F, 204D and any other younger instructions that are memory data dependent on such load-based instruction 204F, 204D need to be reprocessed. The instruction processing circuit 200 could be configured to flush the entire instruction pipeline I₀-I_{N} in response to the flush event 232 whereby the reorder buffer 234 can be used to know the program counter to cause the instruction fetch circuit 210 to re-fetch the flushed load-based instruction 204F, 204D and younger instructions 204F, 204D.

The instruction processing circuit 200 could be alternatively configured to replay the load-based instruction 204F, 204D and any dependent instructions 204F, 204D. When the load check detection circuit 238 detects a mismatch between the received load data 240 and the data stored for the assigned target P₀-P_{X} of the target operand 205T of the load-based instruction 204F, 204D, the load check detection circuit 238 could also be configured to broadcast the load-based instruction's 204F, 204D original assigned target in the RMT circuit 225. This will cause the dependent instructions 204F, 204D on the load-based instruction 204F, 204D to replay and read a new physical register P₀-P_{X} from the PRF 222 instead of the physical register P₀-P_{X} the dependent instructions 204F, 204D were tracking.

The memory data dependency detection circuit 208 can also be configured to invalidate (i.e., flush) the memory data dependency reference circuit 536 associated with the base register of the source operand 205S of the load-based instruction 204F, 204 in response to the flush event 232. The start pointer 506 of the memory data dependency reference circuit 536 and the correct contents of the source entries 500(0)-500(Y) should ideally be repaired in a flush recovery so that memory data dependence information in the memory data dependency reference circuit 536 is updated.

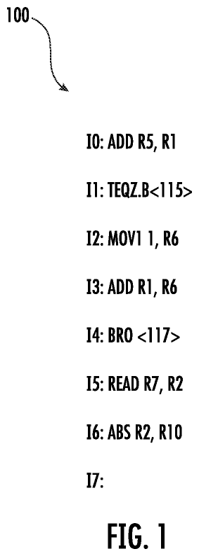

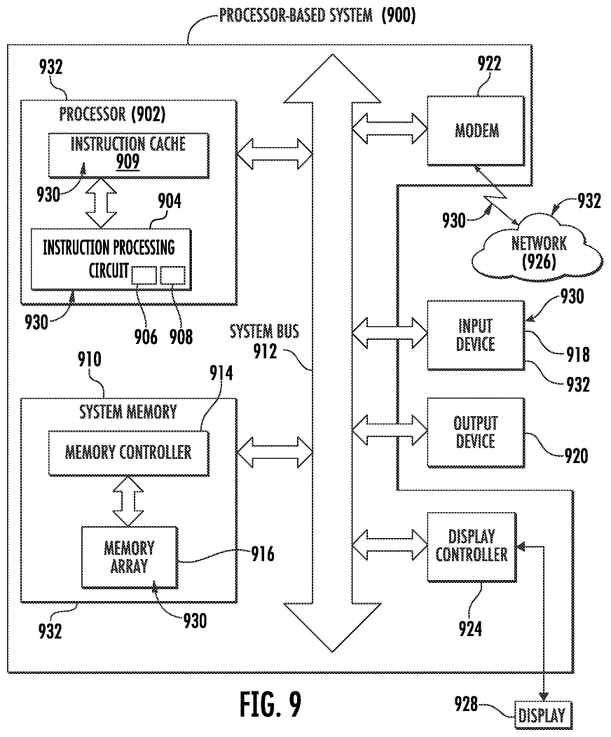

FIG. 9 is a block diagram of an exemplary processor-based system 900 that includes a processor 902 (e.g., a microprocessor) that includes an instruction processing circuit 904 for processing and executing instructions loaded from a memory such as an instruction cache 909 and/or a system memory 910. The processor 902 and/or the instruction processing circuit 904 can include a memory data dependency detection circuit 906 configured to bypass a target assigned to a target operand of a load-based instruction with the designation assigned to a store-based instruction, based on a detected memory data dependency between the store-based instruction and a consumer load-based instruction based on their opcodes as having matching target and source address operand types that can be compared without their target and source addresses being resolved. The processor 902 and/or the instruction processing circuit 904 can also include a load data check circuit 908 configured to initiate a corrective action if the data loaded by execution of a load-based instruction having an opcode calling for a source load address operand identifying a load address that can be compared without the load address being resolved does not match the load data in the bypassed target of the load-based address of the load-based instruction. For example, the processor 902 in FIG. 9 could be the processor 202 in FIG. 1 that includes the instruction processing circuit 200. As another example, the memory data dependency detection circuit 208 in FIG. 2 could be the memory data dependency detection circuit 906 in FIG. 9. As another example, the load data check circuit 238 in FIG. 2 could be the load data check circuit 908 in FIG. 9.

The processor-based system 900 may be a circuit or circuits included in an electronic board card, such as a printed circuit board (PCB), a server, a personal computer, a desktop computer, a laptop computer, a personal digital assistant (PDA), a computing pad, a mobile device, or any other device, and may represent, for example, a server, or a user's computer. In this example, the processor-based system 900 includes the processor 902. The processor 902 represents one or more processing circuits, such as a microprocessor, central processing unit, or the like. The processor 902 is configured to execute processing logic in instructions for performing the operations and steps discussed herein. Fetched or prefetched instructions can be fetched from a memory, such as from a system memory 910, over a system bus 912.

The processor 902 and the system memory 910 are coupled to the system bus 912 and can intercouple peripheral devices included in the processor-based system 900. As is well known, the processor 902 communicates with these other devices by exchanging address, control, and data information over the system bus 912. For example, the processor 902 can communicate bus transaction requests to a memory controller 914 in the system memory 910 as an example of a slave device. Although not illustrated in FIG. 9, multiple system buses 912 could be provided, wherein each system bus constitutes a different fabric. In this example, the memory controller 914 is configured to provide memory access requests to a memory array 916 in the system memory 910. The memory array 916 is comprised of an array of storage bit cells for storing data. The system memory 910 may be a read-only memory (ROM), flash memory, dynamic random access memory (DRAM), such as synchronous DRAM (SDRAM), etc., and a static memory (e.g., flash memory, static random access memory (SRAM), etc.), as non-limiting examples.

Other devices can be connected to the system bus 912. As illustrated in FIG. 9, these devices can include the system memory 910, one or more input devices 918, one or more output devices 920, a modem 922, and one or more display controllers 924, as examples. The input device(s) 918 can include any type of input device, including, but not limited to, input keys, switches, voice processors, etc. The output device(s) 920 can include any type of output device, including, but not limited to, audio, video, other visual indicators, etc. The modem 922 can be any device configured to allow exchange of data to and from a network 926. The network 926 can be any type of network, including, but not limited to, a wired or wireless network, a private or public network, a local area network (LAN), a wireless local area network (WLAN), a wide area network (WAN), a BLUETOOTH™ network, and the Internet. The modem 922 can be configured to support any type of communications protocol desired. The processor 902 may also be configured to access the display controller(s) 924 over the system bus 912 to control information sent to one or more displays 928. The display(s) 928 can include any type of display, including, but not limited to, a cathode ray tube (CRT), a liquid crystal display (LCD), a plasma display, etc.

The processor-based system 900 in FIG. 9 may include a set of instructions 930 to be executed by the instruction processing circuit 904 of the processor 902 for any application desired according to the instructions 930. The instructions 930 may include loops as processed by the instruction processing circuit 904. The instructions 930 may be stored in the instruction cache 909, the system memory 910, and the processor 902 as examples of a non-transitory computer-readable medium 932. The instructions 930 may also reside, completely or at least partially, within the system memory 910, the instruction cache 909, and/or within the processor 902 during their execution. The instructions 930 may further be transmitted or received over the network 926 via the modem 922, such that the network 926 includes the non-transitory computer-readable medium 932.

While the non-transitory computer-readable medium 932 is shown in an exemplary embodiment to be a single medium, the term “computer-readable medium” should be taken to include a single medium or multiple media (e.g., a centralized or distributed database, and/or associated caches and servers) that stores the one or more sets of instructions. The term “computer-readable medium” shall also be taken to include any medium that is capable of storing, encoding, or carrying a set of instructions for execution by the processing device and that causes the processing device to perform any one or more of the methodologies of the embodiments disclosed herein. The term “computer-readable medium” shall accordingly be taken to include, but not be limited to, solid-state memories, optical medium, and magnetic medium.

The embodiments disclosed herein include various steps. The steps of the embodiments disclosed herein may be formed by hardware components or may be embodied in machine-executable instructions, which may be used to cause a general-purpose or special-purpose processor programmed with the instructions to perform the steps. Alternatively, the steps may be performed by a combination of hardware and software.

The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. A machine-readable medium includes any mechanism for storing or transmitting information in a form readable by a machine (e.g., a computer). For example, a machine-readable medium includes: a machine-readable storage medium (e.g., ROM, random access memory (“RAM”), a magnetic disk storage medium, an optical storage medium, flash memory devices, etc.); and the like.

Unless specifically stated otherwise and as apparent from the previous discussion, it is appreciated that throughout the description, discussions utilizing terms such as “processing,” “computing,” “determining,” “displaying,” or the like, refer to the action and processes of a computer system, or similar electronic computing device, that manipulates and transforms data and memories represented as physical (electronic) quantities within the computer system's registers into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The components of the distributed antenna systems described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented or performed with a processor, a Digital Signal Processor (DSP), an Application Specific Integrated Circuit (ASIC), a Field Programmable Gate Array (FPGA), or other programmable logic device, a discrete gate or transistor logic, discrete hardware components, or any combination thereof designed to perform the functions described herein. Furthermore, a controller may be a processor. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The embodiments disclosed herein may be embodied in hardware and in instructions that are stored in hardware, and may reside, for example, in RAM, flash memory, ROM, Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips, that may be references throughout the above description, may be represented by voltages, currents, electromagnetic waves, magnetic fields, or particles, optical fields or particles, or any combination thereof.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications, combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A processor, comprising:
an instruction processing circuit comprising one or more instruction pipelines, the instruction processing circuit configured to fetch a plurality of instructions from a memory into an instruction pipeline among the one or more instruction pipelines;
the instruction processing circuit further comprising a memory data dependency detection circuit configured to:
receive a load-based instruction among the plurality of instructions assigned to the instruction pipeline, the load-based instruction comprising a source operand and a target operand;
determine based on an opcode of the load-based instruction if the source operand of the load-based instruction can be compared without a load address of the source operand being resolved; and
in response to determining the source operand of the load-based instruction can be compared without the load address being resolved:
index a source entry among a plurality of source entries in a memory data dependency reference circuit based on the source operand of the load-based instruction;
retrieve a source tag stored in the indexed source entry in the memory data dependency reference circuit; and
map the retrieved source tag to an assigned target of the target operand of the load-based instruction.

2. The processor of claim 1, wherein the instruction processing circuit further comprises:
a fetch circuit configured to fetch the plurality of instructions from the memory into the instruction pipeline among the one or more instruction pipelines;
an execution circuit configured to execute the fetched plurality of instructions; and
a scheduler circuit configured to issue the fetched plurality of instructions to the execution circuit to be executed;
the memory data dependency detection circuit configured to determine, before a store-based instruction is issued by the scheduler circuit, based on the opcode of the load-based instruction if the source operand of the load-based instruction can be compared without the load address of the source operand being resolved.

3. The processor of claim 1, wherein the memory data dependency detection circuit is further configured to, in response to determining the source operand of the load-based instruction can be compared without the load address being resolved:
determine if a younger instruction than the load-based instruction has a source operand matching the target operand of the load-based instruction; and
in response to the younger instruction having a source operand matching the target operand of the load-based instruction:
map the retrieved source tag to the assigned source of the source operand of the younger instruction.

4. The processor of claim 1, wherein the source operand of the load-based instruction comprises a base register with an offset.

5. The processor of claim 1, wherein the assigned target of the target operand of the load-based instruction comprises a physical register.

6. The processor of claim 1, further comprising:
a physical register file comprising a plurality of physical registers each configured to store data; and
a register map table circuit, comprising:
a plurality of logical register entries each configured to store mapping information to a physical register among the plurality of physical registers in the physical register file;
wherein:
the instruction processing circuit is further configured to assign a physical register in the physical register file mapped to a logical register in the register map table circuit corresponding to the target operand of the load-based instruction; and
the memory data dependency detection circuit is configured to, in response to determining the source operand of the load-based instruction can be compared without the load address being resolved:
map the retrieved source tag to the logical register in the register map table circuit assigned to the target operand of the load-based instruction as the assigned target of the target operand of the load-based instruction.

7. The processor of claim 6, wherein:
the instruction processing circuit is further configured to:
assign a physical register in the physical register file mapped to a logical register in the register map table circuit corresponding to a source operand of a younger instruction than the load-based instruction; and
the memory data dependency detection circuit is further configured to, in response to determining the source operand of the load-based instruction can be compared without the load address being resolved:
determine if the younger instruction than the load-based instruction has a source operand matching the target operand of the load-based instruction; and
in response to the younger instruction having a source operand matching the target operand of the load-based instruction:
map the retrieved source tag to the logical register in the register map table circuit assigned to the source operand of the younger instruction.

8. The processor of claim 1, wherein the memory data dependency reference circuit comprises a circular array comprising the plurality of source entries;
the memory data dependency detection circuit configured to:
index a source entry in the memory data dependency reference circuit based on the source operand of the load-based instruction, starting from a start pointer pointing to a head source entry among the plurality of source entries in the memory data dependency reference circuit.

9. The processor of claim 8, wherein the instruction processing circuit is further configured to update the start pointer to point to a source entry among the plurality of source entries in the memory data dependency reference circuit as an updated head source entry in response to a write operation to the source operand of the load-based instruction.

10. The processor of claim 1, wherein:
each source entry among the plurality of source entries in the memory data dependency reference circuit further comprises a source tag field configured to store the source tag and a valid indicator field configured to store a valid indicator indicating if the source tag is valid; and
the memory data dependency detection circuit is further configured to, in response to determining the source operand of the load-based instruction can be compared without the load address being resolved:
determine if the valid indicator in the valid indicator field of the indexed source entry in the memory data dependency reference circuit indicates a valid state; and
in response to the valid indicator of the indexed source entry indicating a valid state:
retrieve the source tag stored in the source tag field of the indexed source entry in the memory data dependency reference circuit; and
map the retrieved source tag to the assigned target of the target operand of the load-based instruction.

11. The processor of claim 10, wherein the memory data dependency detection circuit is further configured to, in response to the valid indicator of the indexed source entry indicating an invalid state:
not retrieve the source tag stored in the source tag field of the indexed source entry in the memory data dependency reference circuit; and
not map the retrieved source tag to the assigned target of the target operand of the load-based instruction.

12. The processor of claim 10, wherein the memory data dependency detection circuit is further configured to, in response to the valid indicator of the indexed source entry indicating an invalid state:
set the valid indicator to the invalid state in each source entry among the plurality of source entries in the memory data dependency reference circuit.

13. The processor of claim 4, further comprising a plurality of memory data dependency detection circuits each assigned to a source operand type of a load-based instruction that can be compared without the load address of the source operand being resolved;
the memory data dependency detection circuit configured to, in response to determining the source operand of the load-based instruction can be compared without the load address being resolved:
index a source entry among a plurality of source entries in a memory data dependency reference circuit among the plurality of memory data dependency reference circuits assigned to the source operand type of the source operand of the load-based instruction, based on the source operand of the load-based instruction; and
retrieve a source tag stored in the indexed source entry in the assigned memory data dependency reference circuit.

14. The processor of claim 1, wherein the instruction processing circuit further comprises a load data check circuit configured to:
receive load data at the load address of the source operand of the load-based instruction resulting from execution of the load-based instruction; and
compare the received load data to data stored for the assigned target of the target operand of the load-based instruction;
in response to the received load data not matching the data stored for the assigned target of the target operand of the load-based instruction:
generate a flush event to cause the instruction processing circuit to flush at least a portion of the instruction pipeline.

15. The processor of claim 14, wherein the instruction processing circuit is further configured to flush all younger instructions than the load-based instruction in the instruction pipeline in response to the flush event.

16. The processor of claim 14, wherein the instruction processing circuit is further configured to replay the load-based instruction and all younger instructions than the load-based instruction in response to the flush event.

17. The processor of claim 14, wherein the memory data dependency detection circuit is further configured to invalidate each source entry among the plurality of source entries in the memory data dependency reference circuit in response to the flush event.

18. The processor of claim 1, wherein:
the instruction processing circuit is further configured to:
receive a stored-based instruction among the plurality of instructions assigned to the instruction pipeline, the store-based instruction comprising a source operand and a target operand;
assign an assigned source for the source operand of the store-based instruction; and
the memory data dependency detection circuit is further configured to:
determine based on an opcode of the store-based instruction if the target operand of the store-based instruction can be compared without a store address of the target operand being resolved; and
in response to determining the target operand of the store-based instruction can be compared without the store address of the target operand being resolved:
index a source entry among a plurality of source entries in the memory data dependency reference circuit based on the target operand of the store-based instruction; and
store a source tag comprising the assigned source of the source operand of the store-based instruction in the indexed source entry in the memory data dependency reference circuit.

19. The processor of claim 18, wherein:
each source entry among the plurality of source entries in the memory data dependency reference circuit further comprises a source tag field configured to store the source tag and a valid indicator field configured to store a valid indicator indicating if the source tag is valid;
the memory data dependency detection circuit is configured to, in response to determining the target operand of the store-based instruction can be compared without the store address of the target operand being resolved:
store the source tag comprising the assigned source of the source operand of the store-based instruction in the source tag field of the indexed source entry in the memory data dependency reference circuit; and
the memory data dependency detection circuit is further configured to, in response to determining the target operand of the store-based instruction can be compared without the store address of the target operand being resolved:
set the valid indicator to a valid state in the indexed source entry in the memory data dependency reference circuit.

20. A method of removing a memory data dependency between a store-based instruction and a load-based instruction in a processor, comprising:
fetching a plurality of instructions from a memory into an instruction pipeline among one or more instruction pipelines;
receiving a load-based instruction among the plurality of instructions assigned to the instruction pipeline, the load-based instruction comprising a source operand and a target operand;
determining based on an opcode of the load-based instruction if the source operand of the load-based instruction can be compared without a load address of the source operand being resolved; and
in response to determining the source operand of the load-based instruction can be compared without the load address being resolved:
indexing a source entry among a plurality of source entries in a memory data dependency reference circuit based on the source operand of the load-based instruction;
retrieving a source tag stored in the indexed source entry in the memory data dependency reference circuit; and
mapping the retrieved source tag to an assigned target of the target operand of the load-based instruction.

21. The method of claim 20, further comprising, in response to determining the source operand of the load-based instruction can be compared without the load address being resolved:
determining if a younger instruction than the load-based instruction has a source operand matching the target operand of the load-based instruction; and
in response to the younger instruction having a source operand matching the target operand of the load-based instruction:
mapping the retrieved source tag to an assigned source of the source operand of the younger instruction.

22. The method of claim 20, further comprising:
in response to determining the source operand of the load-based instruction can be compared without the load address being resolved:
determining if a valid indicator in a valid indicator field of the indexed source entry in the memory data dependency reference circuit indicates a valid state; and
comprising, in response to the valid indicator of the indexed source entry indicating a valid state,
retrieving the source tag stored in the source tag field of the indexed source entry in the memory data dependency reference circuit; and
mapping the retrieved source tag to the assigned target of the target operand of the load-based instruction.

23. The method of claim 22, further comprising, in response to the valid indicator of the indexed source entry indicating an invalid state:
not retrieving the source tag stored in the source tag field of the indexed source entry in the memory data dependency reference circuit; and
not mapping the retrieved source tag to the assigned target of the target operand of the load-based instruction.

24. The method of claim 20, further comprising:
receiving load data at the load address of the source operand of the load-based instruction resulting front execution of the load-based instruction;
comparing the received load data to data stored for the assigned target of the target operand of the load-based instruction; and
in response to the received load data not matching the data stored for the assigned target of the target operand of the load-based instruction:
generating a flush event to flush at least a portion of the instruction pipeline.

25. The method of claim 20, further comprising:
receiving a stored-based instruction among the plurality of instructions assigned to the instruction pipeline, the store-based instruction comprising a source operand and a target operand;
assigning an assigned source for the source operand of the store-based instruction; and
determining based on an opcode of the store-based instruction if the target operand of the store-based instruction can be compared without a store address of the target operand being resolved; and
in response to determining the target operand of the store-based instruction can be compared without the store address of the target operand being resolved:
indexing a source entry among a plurality of source entries in the memory data dependency reference circuit based on the target operand of the store-based instruction; and
storing a source tag comprising the assigned source of the source operand of the store-based instruction in the indexed source entry in the memory data dependency reference circuit.
